(19) United States
(12) Patent Application Publication
(10) Pub. No.: US 2013/0204719 A1
(43) Pub. Date: Aug. 8, 2013

(54) SYSTEMS AND METHODS FOR LICENSE PLATE RECOGNITION TO ENABLE ADVANCE ORDER PICKUP

(71) Applicants: Aaron Michael Burry, Ontario, NY (US); Peter Paul, Webster, NY (US); Joel Eagle, Anaheim, CA (US)

(72) Inventors: Aaron Michael Burry, Ontario, NY (US); Peter Paul, Webster, NY (US); Joel Eagle, Anaheim, CA (US)

(73) Assignee: XEROX CORPORATION, Norwalk, CT (US)

(21) Appl. No.: 13/364,768

(22) Filed: Feb. 2, 2012

(51) Int. Cl. G06Q 50/12

(52) U.S. Cl. 705/15

(57) ABSTRACT

An embodiment generally relates to systems and methods for processing orders associated with an establishment. In particular, a customer can submit a remote order for goods offered by the establishment, along with an associated license plate number of a vehicle that is to pick up the order. An image capture device can capture images of a vehicle on the premises of the establishment, and provide the images to a processing module which use automatic license plate recognition (ALPR) techniques to determine license plate data of the vehicle. The processing module can further examine an order list to determine if the license plate data is associated with an order on the order list, and, if so, add the order to a priority queue.

### BACKGROUND OF THE INVENTION

Some establishments that offer goods for sale have incorporated a drive-thru that allows individuals to stay in their vehicles throughout ordering and picking up the contents of orders. For example, some fast food restaurants offer a drive-thru window that allows customers to order food and a pick-up window that allows the customers to pick up the food after ordering. The efficient handling of the flow of vehicles through a drive-thru is vital in securing more revenue and retaining more customers.

To improve drive-thru efficiency, some establishments have incorporated remote or Internet-based order placement by customers. In particular, the customer who places a remote order can forego placing the order on-site and can instead pick up the order directly from a pick-up window. However, there are drawbacks in current implementations of the remote ordering systems. In particular, the establishment starts preparing the order contents once the customer arrives at the pick-up window or otherwise notifies the establishment that he/she is ready to pick up the order. For example, a fast food restaurant can start to prepare food associated with a remotely-placed food order once the customer arrives at the pick-up window of the restaurant. Accordingly, the customer must wait for the establishment to prepare and assemble the order.

Therefore, a need exists for systems and methods to efficiently process orders placed with an establishment. In particular, it may be desirable to have platforms and techniques to prepare an order when a vehicle associated with the order enters a premises of an establishment.

### SUMMARY

An embodiment pertains generally to a method of processing orders associated with an establishment. The method comprises receiving image data of a vehicle on a premises of the establishment and processing, by a processor, the image data to determine license plate data associated with the vehicle. Further, the method comprises examining an order list associated with the establishment to determine that an individual associated with the license plate data has placed an order and adding the order to a priority queue in response to examining the order list.

Another embodiment pertains generally to a method of processing orders associated with an establishment. The method comprises receiving an order from an individual via an online ordering interface of the establishment, the order indicating a license plate number associated with the individual, and receiving image data of a vehicle on a premises of the establishment. The method further comprises processing, by a processor, the image data to determine license plate data associated with the vehicle, and determining whether the license plate data matches the license plate number associated with the individual.

Another embodiment pertains generally to a system for processing orders associated with an establishment. The system comprises an image capture device configured to capture image data of a vehicle on a premises of the establishment. Further, the system comprises a processor coupled to the image capture device and configured process the image data to determine license plate data associated with the vehicle, examine an order list associated with the establishment to determine that an individual associated with the license plate data has placed an order, and add the order to a priority queue in response to examining the order list.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates an exemplary environment for processing orders in accordance with embodiments;

FIG. 2A illustrates an exemplary list in accordance with embodiments;

FIG. 2B illustrates an exemplary queue in accordance with embodiments;

FIG. 3 illustrates an exemplary flow diagram of processing orders in accordance with embodiments; and

FIG. 4 illustrates a hardware diagram in accordance with embodiments.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Embodiments generally relate to systems and methods for processing orders associated with an establishment. More particularly, a customer of the establishment can remotely submit an order for goods and/or services offered by the establishment, whereby the order can indicate a license plate number associated with the customer. Further, an image capturing device of the establishment can be configured to capture images of a vehicle on a premises of the establishment. Additionally, a processing module or other logic can receive image data from the image capturing device, and can perform automatic license plate recognition (ALPR) techniques on the image data to determine license plate data associated with the vehicle. Further, the processing module can determine if the license plate number of the order matches the determined license plate data and, if so, can add the order to a priority queue that signals the establishment to start preparing and assembling the contents of the order.

By incorporating the systems and methods, establishments and their customers can realize various benefits. For example, the time necessary to process drive-thru orders can be decreased, and more total orders can be processed by the establishment, resulting in increased revenue. Further, the systems and methods can reduce the inconvenience for the customer by not requiring additional actions subsequent to placing the order and ensuring that the orders are added to a priority queue in a timely fashion upon the customer's arrival. Accordingly, the establishments can realize increased customer retention. It should be appreciated that other benefits of the systems and methods are envisioned.

As used herein, the term “establishment” or variations thereof can be a general term that can refer to any place of business that can offer goods and/or services for sale and/or pick-up via a drive-thru window or similar system. For example, an establishment can be a restaurant, bank, postal service, coffee shop, dairy store, liquor store, pharmacy, and/or the like. Further, as used herein, the term “automatic license plate recognition” or “ALPR” can refer to any type of algorithm or technique for analyzing image data to determine or identify license plate data, such as alphanumeric characters, state or jurisdiction of issuance, and/or other data. In operation, the ALPR algorithms and techniques can use plate localization, plate orientation and sizing, normalization, character segmentation, optical character recognition, syntactical and/or geometrical analysis, and/or other techniques. Further, it should be appreciated that any type of hardware, software, and/or combinations thereof can be used to process the image data and perform the ALPR techniques and algorithms.

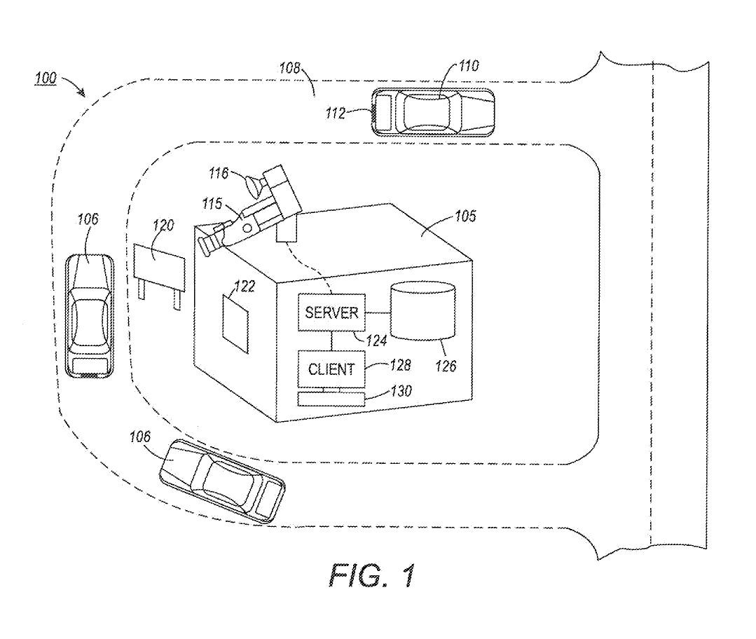

FIG. 1 depicts an exemplary environment 100 in which the systems and methods can be implemented, in accordance with embodiments. It should be readily apparent to one of ordinary skill in the art that the environment 100 depicted in FIG. 1 represents a generalized schematic illustration and that other components can be added or existing components can be removed or modified.

As shown in FIG. 1, the environment 100 can represent a premises associated with an establishment 105. The establishment 105 can comprise a drive-thru lane 108 on which a set of vehicles 106 can traverse. In particular, respective operators of the set of vehicles 106 can place an order for food or other products offered by the establishment 105 via a drive-thru window 120, and pay for the order via a pay window 122.

According to embodiments, the establishment 105 can comprise a camera 115 positioned thereon. The camera 115 can be any type of image capturing device and can be positioned or oriented in such a way that it can be directed towards or otherwise configured to capture information on a license plate 112 of a vehicle 110 on the premises. In particular, the camera 115 can be configured to capture image data directed to the license plate 112 of the vehicle 110. It should be appreciated that there can be multiple cameras 115 positioned in other locations of the premises such as, for example, near an entrance to the premises, near the drive-thru window 120, and/or in other locations.

The camera 115 can be configured with at least one light 116 that can be configured to illuminate an area in which the vehicle 110 is driving, such as in low light or night environments, in order to aid in the image capture of the license plate 112. In embodiments, the light 116 can be a visible light, infrared light, or other form of light. According to embodiments, the camera 115 can be configured to capture one or more images of the vehicle 110 and the associated license plate 112 upon the vehicle 110 entering the premises of the establishment. For example, the camera 115 can take one or more images of the vehicle 110 and the license plate 112 after the vehicle 110 turns off a road and onto an entryway of the premises, such as the drive-thru lane 108. However, it should be appreciated that the camera 115 can take the one or more images at any point. Further, in embodiments, the camera 115 can be configured with a motion sensor that can detect when the vehicle enters the premises, and capture the image data in response to detecting when the vehicle enters the premises. In some cases, the motion sensor can be a loupe sensor or similar component that can be embedded or otherwise disposed in a roadway or in other locations of the environment 100.

The camera 115 can be configured to connect to a server 124. For example, the camera 115 can transmit image data of the vehicle 110 and the license plate 112, or other images, to the server 124 for processing or storage on, for example, a database 126 or other type of storage. In embodiments, the server 124 can be connected locally to or remotely from the camera 115. For example, the camera 115 can be located near an entryway of the premises and the server 124 can be located within the establishment 105. Further, in embodiments, the camera 115 can be configured to transmit image data to the server 124 via any type of hardwired, wireless, cellular, satellite, or other type of data network.

In embodiments, the server 124 can be coupled to and/or can be configured to connect to a client machine 128. Further, in embodiments, the server 124 can be configured to provide the client 128 with image data captured by the camera 115, or other data. In some cases, the client machine 128 can be a part of the server 124. Further, the server 124 can be configured to transmit image data to the client 128 via any type of hardwired, wireless, cellular, satellite, or other type of data network. In embodiments, the client 128 can comprise a processing module 130 that can be any type of hardware, software, application, or other processing entity that can be configured to be executed on the client 128 and perform analyses on the received image data, or other data.

According to embodiments, an individual associated with the vehicle 110, such as an operator or other individual, can submit an order for a product, such as food, offered by the establishment 105. The order can be submitted remotely and in advance of the vehicle 110 arriving at the premises of the establishment 106. For example, the individual can submit an order via an online ordering system of the establishment 105 from a home computer or device. For further example, the individual can submit an order via a mobile application on a mobile device. Further, for example, the individual can call the establishment 105 to place an order.

In some cases, the individual can create a profile with the online ordering system, the mobile application, and/or the like. Further, the individual can associate one or more license plate numbers with the profile. The one or more license plate numbers can then be associated with any order placed by the individual when signed into the profile. For example, a profile associated with a household can have multiple associated vehicle license plate numbers. In other cases, the individual can enter license plate information when placing the order. For example, the individual can input, via an ordering system, the license plate number of the vehicle that will be picking up the order. For further example, if the individual places an order over the phone, the individual can tell the operator the license plate number of the vehicle that will be picking up the order.

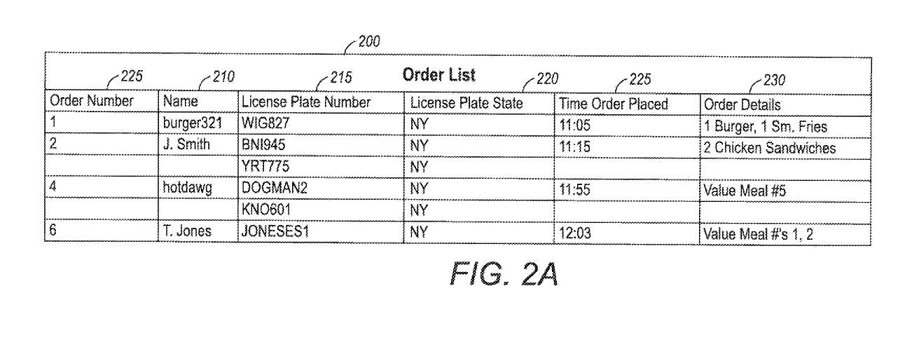

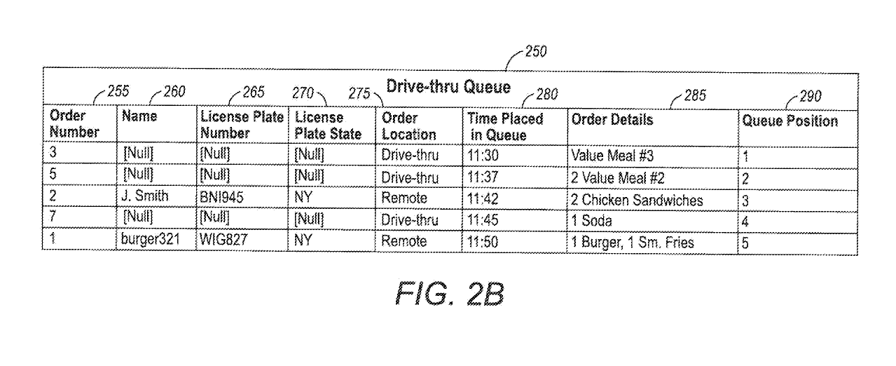

Upon receiving the order, the establishment 105 can place the order on an order list with any other received orders. More particularly, the order list can comprise a listing of the received orders, details of the orders, license plate data associated with the orders and/or with profiles of individuals who placed the orders, and/or other information. Referring to FIG. 2A, depicted is an exemplary order list 200 consistent with embodiments. It should be appreciated that the order list 200 is merely exemplary and can comprise various combinations of data in various arrangements.

As shown in FIG. 2A, the order list 200 can comprise an order number column 205, a name column 210, and a license plate number column 215. More particularly, the order number column 205 comprises an order number for each received order, the name column 210 comprises a name or profile associated with the order, and the license plate number column 215 comprises one or more license plate numbers associated with the individual or profile listed in the name column 210. For example, order number 2 was placed by “J. Smith,” who has associated license plate numbers “BNI945” and “YRT775.” Further, the order list 200 comprises a license plate state column 220 that lists a state (or other jurisdiction) associated with each license plate in the license plate column 215, a time order placed column 225 that lists the time that each order is placed, and an order details column 230 that lists the products (e.g., food) ordered for each order.

Referring back to FIG. 1, the processing module 130 can be configured to process received image data. In particular, the processing module 130 can process the image data to determine any license plate data associated with the license plate 112 of the vehicle 110. For example, the processing module 130 can process the image data to determine the license plate number and the state of issuance for each license plate. It should be that any ALPR technique or algorithm is envisioned to determine the license plate numbers and jurisdictions of issuance.

Upon determining the license plate data associated with the license plate 112, such as the alphanumeric characters of the license plate 112 and the jurisdiction of issuance, the processing module 130 can compare the license plate data with an order list associated with the establishment 205, such as the order list 200 explained with respect to FIG. 2A. If the determined license plate data matches any license plate data associated with an order on the order list, then the matching order can be moved to a drive-thru queue, priority list, or other similar type of record. More particularly, the drive-thru queue or priority list can comprise a listing of orders to be immediately processed by the establishment 105. For example, if the establishment 105 is a fast food restaurant, then once an order is placed on the drive-thru queue, the establishment 105 can start preparing and/or organizing the food associated with the order. In some cases, the processing module 130 can assign a drive-thru queue position to the vehicle 110 after matching the license plate 112 to an order of the order list 200. For example, if there are four (4) vehicles already in the drive-thru lane 108 and the license plate 112 of the vehicle 110 is matched to an order of the order list 200, then the processing module 130 can assign queue position five (5) to the vehicle 110.

Referring to FIG. 2B, depicted is an exemplary drive-thru queue 250 consistent with embodiments. It should be appreciated that the drive-thru queue 250 is merely exemplary and can comprise various combinations of data in various arrangements.

As shown in FIG. 2B, the drive-thru queue 250 can comprise an order number column 255, a name column 260, and a license plate number column 265. More particularly, the order number column 255 comprises an order number for each order in the queue 250, the name column 260 comprises a name or profile associated with the order, and the license plate number column 265 comprises a license plate number that was determined by the ALPR techniques, as discussed herein. For example, once the license plate “BNI945” is identified as being on the premises of the establishment 105, the processing module 130 can move the associated order number 2 from the order list 200 to the drive-thru queue 250.

The drive-thru queue 250 can further comprise a license plate state column 270 that lists a state associated with the identified license plate in the license plate column 265, an order location column 275 that lists a location where the order was placed (e.g. at the drive-thru window or remotely), a time placed in queue column 280 that lists when each order was placed in the drive-thru queue 250, and an order details column 285 that lists the products (e.g., food) associated with each order. In some cases, the drive-thru queue 250 can comprise a queue position column 290 that can list a queue position order, in a drive-thru lane, of the vehicles associated with the order number.

Referring back to FIG. 1, once a matching order, such as an order associated with the vehicle 110, is added to the drive-thru queue, the establishment 105 and/or employees thereof can process the order according to the order details. For example, if the matching order specifies two meals, then kitchen employees of the establishment 105 can view the order details and prepare the two meals. Once the vehicle 110 corresponding to the matching order reaches the pay window 122, or otherwise when the vehicle 110 reaches the front queue position, then the employees of the establishment 105 can provide the contents of the order to the operator of the vehicle 110.

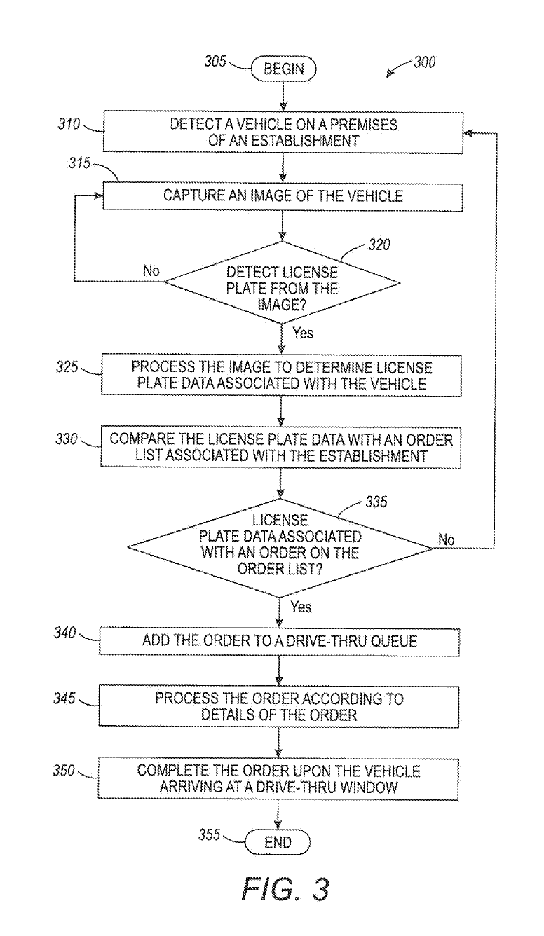

FIG. 3 illustrates a flow diagram of an order processing technique 300 according to embodiments. It should be readily apparent to those of ordinary skill in the art that the flow diagram depicted in FIG. 3 represents a generalized illustration and that other steps can be added or existing steps can be removed or modified.

In embodiments, the processing module 130, the camera 115, or other logic can be configured to perform part or all of the technique 300. In 305, processing can begin. In 310, the processing module can detect a vehicle on a premises of an establishment. In some cases, the processing module can detect the vehicle via motion detectors on one or more cameras positioned near or directed to an entrance to the premises, or via one or more loupe sensors embedded in a roadway near the premises. In 315, the camera can capture one or more images of the vehicle. In embodiments, the processing module can receive image data captured by the camera.

In 320, the processing module can determine if a license plate can be detected from the image. In some cases, the vehicle can be angled such that the license plate is not visible, or the image data can be too blurry to detect a license plate. If the license plate cannot be detected from the image (NO), then the camera can take an additional image of the vehicle. In contrast, if the license plate can be detected from the image (YES), then the processing module can process (325) the image to determine license plate data associated with the vehicle. In embodiments, the processing module can employ any type of ALPR technique or algorithm to identify the alphanumeric characters of the license plate, as well as the jurisdiction of issuance of the license plate.

In 330, the processing module can compare the license plate data with an order list associated with the establishment. For example, the order list can list each order received via a remote ordering system or interface of the establishment. In 335, the processing module can determine if the license plate data is associated with an order on the order list. In some cases, an individual who submits an order can have an associated profile listing one or more license plate numbers. In other cases, the individual who submits the order can specify a license plate number of a vehicle that will be picking up the order. If the license plate data is not on the order list (NO), then processing can return to 310. In contrast, if the license plate data is associated with an order on the order list, then the processing module can add (340) the order to a drive-thru queue or other similar data structure. In some cases, the processing module scan assign the vehicle, and/or its associated license plate data, a position in the drive-thru queue.

In 345, the processing module can process the order according to details of the order. For example, if the establishment is a fast food restaurant, then the processing module can inform employees of the restaurant to begin preparing the food specified in the order. In 350, the processing module can complete the order upon the vehicle arriving at a drive-thru window. For example, the processing module can mark the order as complete once the products specified in the order are handed or otherwise delivered to an operator of the vehicle. In 355, processing can end, repeat, or return to any of the previous steps.

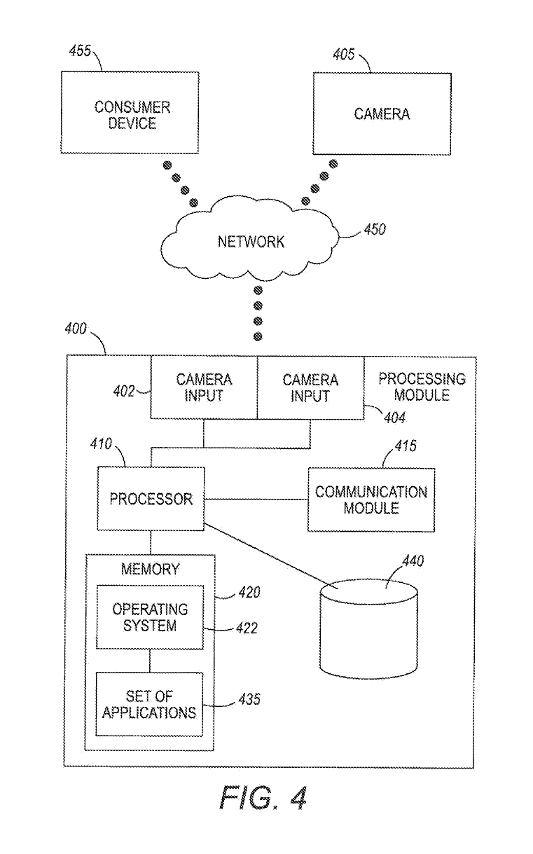

Referring to FIG. 4, depicted is an exemplary processing module 400 and components thereof. It should be appreciated that FIG. 4 represents a generalized schematic illustration and that other components and/or entities can be added or existing components and/or entities can be removed or modified.

As shown in FIG. 4, the processing module 400 can comprise a set of ports that can receive input signals or data from, or output signals or data to, other components such as a camera 405, as discussed herein. More particularly, a camera input port 402 can be configured to receive image data from the camera 405. Similarly, a camera output port 404 can be configured to send data to the camera 405. For example, the components of the processing module 400 can instruct the camera 405 to capture additional images if a received image is blurry.

The processing module 400 can further comprise a processor 410 communicating with a memory 420, such as electronic random access memory, or other forms of transitory or non-transitory computer readable storage mediums, operating under control of or in conjunction with an operating system 422. The operating system 422 can be any commercial, open-source, or proprietary operating system or platform. The processor 410 can communicate with a database 440, such as a database stored on a local hard drive. While illustrated as a local database in the processing module 400, the database 440 can be separate from the processing module 400.

The processor 410 can further communicate with a communication module 415, such as a wired or wireless data connection, which in turn communicates with one or more networks 450, such as various public or private wide-area or local networks. More particularly, the network 450 can connect the processing module 400 to the camera 405. Further, the network 450 can connect the processing module 400 to one or more consumer devices 455 such as, for example, computers, mobile device, and/or the like.

The processor 410 can communicate with a set of applications 435 that can be configured to execute control logic and perform data processing to perform the functions and techniques as discussed herein. For example, the set of applications 435 can include an ALPR application configured to identify license plate data in an image and an online ordering application configured to receive orders from the consumer device 455. It should be appreciated that other applications 435 and functionalities are envisioned.

While FIG. 4 illustrates the processing module 400 as a standalone system using a combination of hardware and software, the components of the processing module 400 can also be implemented as a software application or program capable of being executed by a conventional computer platform. Likewise, the components of the processing module 400 can also be implemented as a software module or program module capable of being incorporated in other software applications and programs. In either case, the components of the processing module 400 can be implemented in any type of conventional proprietary or open-source computer language.

Certain embodiments can be performed as a computer program. The computer program can exist in a variety of forms both active and inactive. For example, the computer program can exist as software program(s) comprised of program instructions in source code, object code, executable code or other formats; firmware program(s); or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

1. A method of processing orders associated with an establishment, the method comprising:
receiving an order, wherein the order is associated with license plate text;
adding the order to an order list associated with the establishment;
receiving image data of a vehicle on a premises of the establishment;
processing, by a processor, the image data to determine license plate data associated with the vehicle;
determining that the license plate data associated with the vehicle matches the license plate text associated with the order by examining the order list; and
adding the order to a priority queue in response to determining that the license plate data associated with the vehicle matches the license plate text associated with the order.

2. The method of claim 1, wherein receiving the image data of the vehicle comprises:
detecting the vehicle on the premises of the establishment; and
capturing the image data of the vehicle in response to detecting the vehicle.

3. The method of claim 1, wherein receiving the image data of the vehicle comprises:
sensing, by a motion detector, the vehicle entering the premises of the establishment; and
capturing the image data of the vehicle in response to sensing the vehicle entering the premises.

4. The method of claim 1, further comprising:
determining that the vehicle has received content associated with the order; and
completing the order in response to the determining.

5. The method of claim 1, further comprising:
assigning the vehicle a position in the priority queue.

6. The method of claim 1, wherein:
the order is received via a remote ordering interface associated with the establishment.

7. (canceled)

8. A method of processing orders associated with an establishment, the method comprising:
receiving instructions to create a profile for an individual for an online ordering interface of the establishment, wherein the profile is associated with one or more license plate numbers;
receiving an order via the online ordering interface of the establishment;
adding the order to an order list associated with the establishment;
receiving image data of a vehicle on a premises of the establishment;
processing, by a processor, the image data to determine license plate data associated with the vehicle;
determining whether the license plate data matches one of the one or more license plate numbers associated with the profile for the individual by examining the order list; and
adding the order to a priority queue in response to determining that the license plate data matches one of the one or more license plate numbers.

9. The method of claim 8, wherein when the license plate data does not match any of the one or more license plate numbers associated with the profile of the individual, further comprising:
receiving additional image data of a second vehicle on the premises of the establishment;
processing, by the processor, the additional image data to determine additional license plate data associated with the second vehicle; and
determining whether the additional license plate data matches one of the one or more license plate numbers associated with the profile of the individual.

10. The method of claim 8, further comprising assigning the vehicle a position in the priority queue in response to determining that the license plate data matches one of the one or more license plate numbers.

11. The method of claim 8, wherein receiving the image data of the vehicle comprises:
detecting the vehicle on the premises of the establishment; and
capturing the image data of the vehicle in response to detecting the vehicle.

12. The method of claim 8, wherein receiving the image data of the vehicle comprises:
sensing, by a motion detector, the vehicle entering the premises of the establishment; and
capturing the image data of the vehicle in response to sensing the vehicle entering the premises.

13. The method of claim 10, further comprising:
determining that the vehicle has received content associated with the order; and
completing the order in response to the determining.

14. (canceled)

15. A system for processing orders associated with an establishment, the system comprising:
an image capture device configured to capture image data of a vehicle on a premises of the establishment;
a processor coupled to the image capture device and configured to perform actions comprising:
receiving an order, wherein the order is associated with license plate text;
adding the order to an order list associated with the establishment;
processing the image data to determine license plate data associated with the vehicle;
determining that the license plate data associated with the vehicle matches the license plate text associated with the order by examining the order list; and
adding the order to a priority queue in response to determining that the license plate data associated with the vehicle matches the license plate text associated with the order.

16. The system of claim 15, wherein the image capture device is further configured to:
detect the vehicle on the premises of the establishment; and
capture the image data of the vehicle in response to detecting the vehicle.

17. The system of claim 15, wherein the processor is further configured to perform actions comprising:
determining that the vehicle has received content associated with the order; and
completing the order in response to the determining.

18. The system of claim 15, wherein the processor is further configured to perform actions comprising:
assigning the vehicle a position in the priority queue.

19. The system of claim 15, wherein the order is received via a remote ordering interface associated with the establishment.

20. (canceled)
